(19) United States
(12) Patent Application Publication
(10) Pub. No.: US 2025/0007193 A1
(43) Pub. Date: Jan. 2, 2025

(54) Hybrid SPE Connector Unit

(71) Applicant: TE Connectivity Nederland B.V., s'Hertogenbosch (NL)

(72) Inventors: Jeroen Jozef Maria De Bruijn, S'Hertogenbosch (NL); Wijnand Van Gils, s-Hertogenbosch (NL)

(73) Assignee: TE Connectivity Nederland B.V., s'Hertogenbosch (NL)

(21) Appl. No.: 18/756,236

(22) Filed: Jun. 27, 2024

(30) Foreign Application Priority Data
Jun. 27, 2023 (EP) 23181763.6

(51) Int. Cl. H01R 12/72; H01R 13/717; H01R 13/7193; H01R 27/00

(52) U.S. Cl. CPC H01R 12/722; H01R 27/00; H01R 13/7175; H01R 13/7193

(57) ABSTRACT

A hybrid SPE connector unit includes a housing, a male hybrid SPE input connector mounted on the housing, and at least one female SPE output connector mounted on the housing. The female SPE output connector is selected from a group of connectors including a female SPE only connector and a female hybrid SPE connector. The housing has a PCB side with a mechanical interface and an electrical interface for mounting and connecting the hybrid SPE connector unit to a PCB.

### CROSS-REFERENCE TO RELATED APPLICATIONS

This application claims the benefit of the filing date under 35 U.S.C. § 119 (a)-(d) of European Patent Application No. 23181763.6, filed on Jun. 27, 2023.

### FIELD OF THE INVENTION

The invention relates to a connector unit and, more particularly to a hybrid Single-Pair Ethernet (SPE) connector unit.

### BACKGROUND OF THE INVENTION

Hybrid SPE connector units are used for interconnecting printed circuit boards (PCBs) or other electrical devices with a hybrid SPE topology, such as a hybrid SPE ring structure or a multidrop topology. A hybrid SPE connector unit usually includes hybrid SPE connectors containing contacts for SPE and contacts for power transmission, such as the hybrid connectors given in IEC 63171-6 and IEC 63171-7.

Single-Pair Ethernet (SPE) is a more recent standard for two-wire Ethernet connections, particularly in the automotive and industrial sectors. The IEEE 802.3bu-2016 standard deals with power supply over SPE connections, which are referred to as hybrid SPE connections. The current hybrid SPE connector units available on the market, however, often require a complicated and elaborate layout of the PCBs and are not very space-saving.

### SUMMARY OF THE INVENTION

A hybrid SPE connector unit includes a housing, a male hybrid SPE input connector mounted on the housing, and at least one female SPE output connector mounted on the housing. The female SPE output connector is selected from a group of connectors including a female SPE only connector and a female hybrid SPE connector. The housing has a PCB side with a mechanical interface and an electrical interface for mounting and connecting the hybrid SPE connector unit to a PCB.

### BRIEF DESCRIPTION OF THE DRAWINGS

Embodiments of the invention are shown in the drawings and explained in more detail in the following description.

FIG. 1 is a schematic perspective view of a hybrid SPE connector unit according to a possible embodiment;

FIG. 2 is a schematic perspective view of a hybrid SPE connector unit according to a possible embodiment, mounted on a PCB;

FIG. 3 is a schematic sectional view of a hybrid SPE connector unit according to a possible embodiment, mounted on a PCB;

FIG. 4 is a schematic perspective view of a hybrid SPE connector unit according to another possible embodiment;

FIG. 5 is a schematic perspective view of a hybrid SPE connector unit according to another possible embodiment;

FIG. 6 is a schematic perspective view of a hybrid SPE connector unit according to possible embodiment, mounted on a PCB;

FIG. 7 is a schematic diagram of a hybrid SPE connector unit according to a possible embodiment;

FIG. 8 is a schematic diagram of a hybrid SPE connector unit according to another possible embodiment;

FIG. 9 is a schematic diagram of a hybrid SPE connector unit according to a further possible embodiment;

FIG. 10 is a schematic perspective view of a hybrid SPE connector unit according to another possible embodiment, without a housing;

FIG. 11 is a schematic perspective view of a hybrid SPE connector unit according to another possible embodiment; and

FIG. 12 is a schematic perspective view of a hybrid SPE connector unit according to a further possible embodiment.

### DETAILED DESCRIPTION

In the following, the invention is explained exemplarily in more detail with reference to the drawings and in accordance with several embodiments, the different features of which can be combined with one another as desired in accordance with the general description. Moreover, a feature may be omitted from the below embodiments if its technical effect is not required in a particular application. Likewise, a feature described herein that is not present in an embodiment may be added if its technical effect is not essential for a particular application. In the following, the same reference numerals are used for elements that correspond to each other with respect to at least one of structure and function.

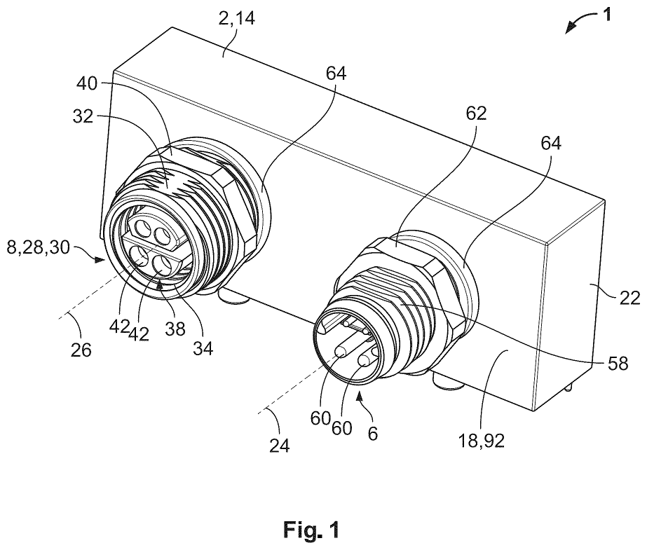

In the following, a hybrid SPE connector unit according to several embodiments will be described with reference to FIGS. 1 to 12.

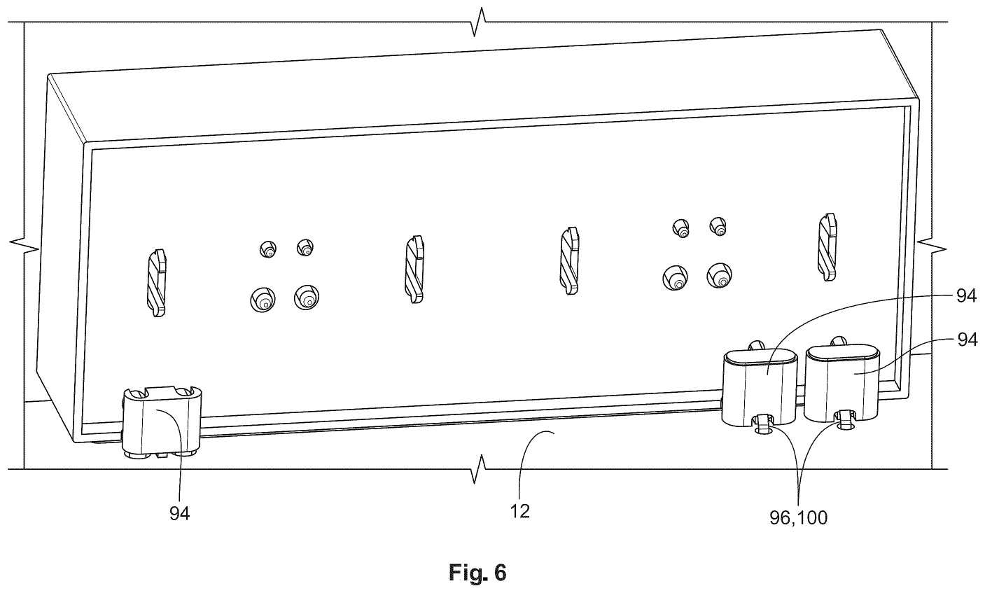

The hybrid SPE connector unit 1 comprises a housing 2, a circuit board 4, a male hybrid SPE input connector 6, at least one female SPE output connector 8, and multiple components 10. The hybrid SPE connector unit 1 may be provided for interconnecting a PCB 12 with an SPE ring structure, as shown in FIG. 6.

The provision of the circuit board 4 makes it possible to integrate further functionalities into the hybrid SPE connector unit 1. Such a hybrid SPE connector unit 1 is thus able to take over functionalities of the PCBs 12. This increases the application range of the hybrid SPE connector unit 1. Further, the system design costs of the PCBs 12, which are connected to the hybrid SPE connector unit 1, and thus the overall connectivity costs are reduced.

The housing 2 has a substantially cuboid shape that has a top 14, a bottom 16, a front side 18, a backside 20 and two opposite side walls 22. In other embodiments, the housing 2 may have any other geometrical shape that comprises different sides. The housing 2 may further be electromagnetically shielded. The electromagnetic shielding may be integrally formed with the housing 2 or may be a separate component that is attached to the housing 2.

The front side 18 of the housing 2 comprises the male hybrid SPE input connector 6 and the female SPE output connector 8, via which the hybrid SPE connector unit 1 may be connected to a SPE topology, such as a SPE ring structure. A longitudinal axis 24 of the male hybrid SPE input connector 6 and a longitudinal axis 26 of the female SPE output connector 8 extend parallel to each other and perpendicular to the front side 18 of the housing 2, as shown in FIG. 1.

In an embodiment, the at least one female SPE output connector 8 may be smaller than the male hybrid SPE input connector 6. In principle, larger SPE connectors have larger contacts and wires, which is why larger SPE connectors can also transmit greater power. Having a large male hybrid SPE input connector 6 allows to place larger power leads or terminals within the connector. This input power may then be distributed to one or more female hybrid SPE output connectors 28, which each transmits less power than the male hybrid SPE input connector 6 and therefore may be smaller than the hybrid male SPE input connector 6. This reduces the size of the hybrid SPE connector unit 1.

The male hybrid SPE input connector 6 complies with the standard of IEC 63171-6. The female SPE output connector 8 shown in FIG. 1 is a female hybrid SPE connector 28 in accordance with the standard of IEC 63171-6. The hybrid SPE input connector 6 and the at least one female SPE output connector 8 may have an M6, M8, M12 or larger size. The hybrid SPE input connector 6 and the at least one female SPE output connector 8 may be in accordance with the standard IEC 63171 series. According to another embodiment, the female SPE output connector 8 may be a female SPE connector 30. Further, multiple female SPE connectors 30 and/or female hybrid SPE connectors 28 may be provided on the hybrid SPE connector unit 1.

The female SPE output connector 8 may comprise an outer thread 32, an inner thread 34, contact pins 36, a pin protection 38 and a screw nut 40. The outer thread 32 of the female SPE output connector 8 is provided for engaging a complementary inner thread of a mating female hybrid SPE output connector 28. The inner thread 34 is provided for engaging a complementary outer thread of a mating male hybrid SPE input connector and/or a mating male SPE input connector.

The contact pins 36 of the female SPE output connector 8 are not visible in FIG. 1, as they are concentrically surrounded by cylindrical cavities 42 of the pin protection 38. The pin protection 38 may be provided as a touch protection of the contact pins 36 of the female SPE output connector 8. The pin protection 38 may comprise a monolithically formed component that concentrically surrounds the contact pins 36, 60. The pin protection 38 may e.g. serve the purpose of a touch protection and/or an electromagnetic shielding. In particular, contact with the current-carrying components may be prevented by a human finger of a user, simulated for example by a test finger according to the standard of DIN EN 60529:2000.

The contact pins 36 of the female SPE output connector 8 are provided for transmitting power and/or data between the SPE ring structure and the hybrid SPE connector unit 1. In case the female SPE output connector 8 is a female hybrid SPE connector 28, power and data are each transmitted via separate pairs of contact pins 36. Thereby, a physical separation of the power transmission and the data transmission is achieved. In case the female SPE output connector 8 is a female SPE connector 30, power and data are transmitted via a same pair of contact pins 36.

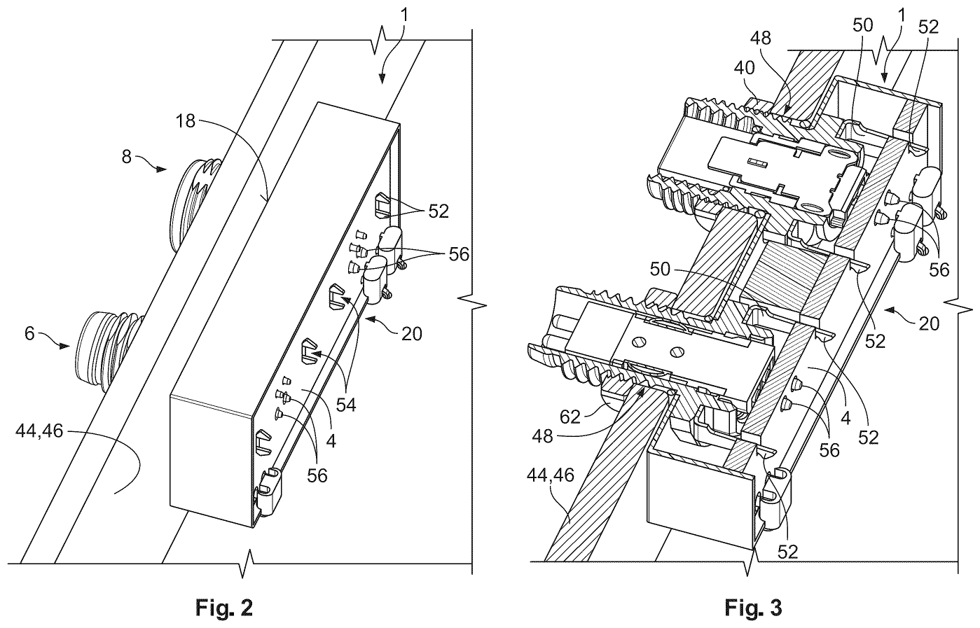

The screw nut 40 of the female SPE output connector 8 may be used for attaching the female SPE output connector 8 to the housing 2 or to the circuit board 4. In particular, the circuit board 4 may form a part of the housing 2. As shown in FIGS. 2 and 3, the hybrid SPE connector unit 1 may be attached to a wall 44 of an outer housing 46 by using the screw nut 40 of the female SPE output connector 8 and a screw nut 62 of the male hybrid SPE input connector 6. For attaching, both the female SPE output connector 8 and the male SPE input connector 6 are inserted into through holes 48 in the outer housing 46, until the front side 18 of the housing 2 abuts against the wall 44 of the outer housing 46. As the screw nuts 40, 62 are tightened, the hybrid SPE connector unit 1 is attached to the outer housing 46. Both the male hybrid SPE input connector 6 and the female SPE output connector 8 may be connected to the circuit board 4 that is part of the hybrid SPE connector unit 1. In an embodiment, the circuit board 4 may form the backside 20 of the housing 2 of the hybrid SPE connector unit 1.

The mechanical connection between both the male hybrid SPE input connector 6 and the female SPE output connector 8 with the circuit board 4 is established by using metal brackets 50. The metal brackets 50 comprise latching hooks 52 for establishing a form-locking connection 54, shown in FIG. 2, with the circuit board 4. Both the male hybrid SPE input connector 6 and the female SPE output connector 8 are electrically connected to the circuit board 4 via rear contacts 56 that are inserted into complementary holes of the circuit board 4. The circuit board 4 may also be located in the housing 2.

The male hybrid SPE input connector 6 may comprise an outer thread 58, contact pins 60 and a screw nut 62. The outer thread 58 of the male hybrid SPE input connector 6 is provided for engaging a complementary inner thread of a mating female hybrid SPE connector 28. The outer thread 58 may have the size of M8 or M12. In an embodiment, the thread of the male hybrid SPE input connector 6 may have a larger diameter than the thread of the female SPE output connector 8 and/or the thread of the female hybrid SPE output connector 28. The male hybrid SPE input connector 6 may be M12 and at least one female SPE output connector 8 may be M6, M8 or M12, or the male hybrid SPE input connector 6 may be M8 and at least one female SPE output connector 8 may be M6 or M8.

The contact pins 60 of the male hybrid SPE input connector 6 are provided for transmitting both power and data. In particular, both power and data are transmitted via a single pair of contact pins 60. In analogy to the screw nut 40 of the female SPE output connector 8, the screw nut 62 of the male hybrid SPE input connector 6 may be used for attaching the hybrid SPE connector unit 1 to the wall 44 of the outer housing 46. The male hybrid SPE input connector 6 shown in FIG. 1 does not comprise a pin protection 38. Nevertheless, the male hybrid SPE input connector 6 may also comprise the pin protection 38 as provided on the female SPE output connector 8. The contact pins 36, 60 of both the male hybrid SPE input connector 6 and at least one female hybrid SPE output connector 28 may be protected or unprotected.

The hybrid SPE connector unit 1 further may comprise toroidal sealing elements 64 (see FIG. 1). The sealing elements 64 abut the front side 18 of the housing 2 and concentrically extend around the longitudinal axis 24 of the male hybrid SPE input connector 6 and around the longitudinal axis 26 of the female SPE output connector 8, respectively. When the screw nuts 40, 62 are tightened, the sealing elements 64 are compressed between the screw nuts 40, 62 and the front side 18 of the housing 2.

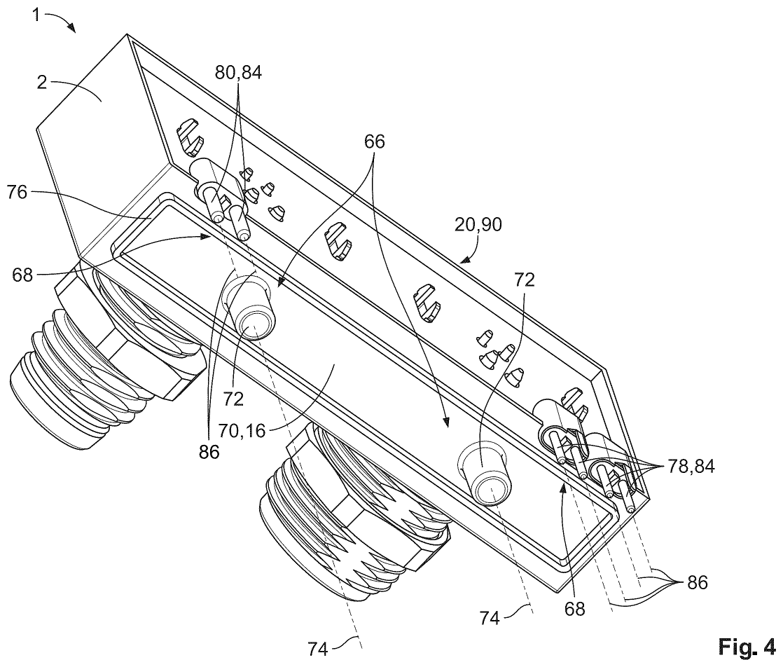

As best seen in in FIG. 4, the hybrid SPE connector unit 1 further may comprise a mechanical interface 66 and an electrical interface 68, which are located at a PCB side 70 of the hybrid SPE connector unit 1. In the embodiment shown in FIG. 4, the PCB side 70 corresponds to the bottom 16 of the housing 2. In general, the PCB side 70 may be regarded as the side of the housing 2, where the mechanical interface 66 and the electrical interface 68 are located, and via which the hybrid SPE connector unit 1 is connected to a PCB 12.

The male hybrid SPE input connector 6 and at least one female SPE output connector 8 may be mounted on the same side of the housing 2 or on different sides of the housing 2. The PCB side 70 may be opposite to the side where the male hybrid SPE input connector 6 is located. In an embodiment, the PCB side 70 may extend perpendicular to the side where the male hybrid SPE input connector 6 is located.

The mechanical interface 66 may be provided for mounting the hybrid SPE connector unit 1 on the PCB 12. The bottom 16 of the housing 2 may be provided with pins 72, which longitudinal axes 74 extend perpendicular to the bottom 16 of the housing 2. In an embodiment, the pins 72 are monolithically formed with the housing 2. The pins 72 are designed for being inserted into complementary retention holes of the PCB 12. The mechanical interface 66 may further comprise a rectangular, frame-shaped protrusion 76 that perpendicularly faces away from the bottom 16 of the housing 2. The protrusion 76 may be monolithically formed by the housing 2. The protrusion 76 may be designed for being inserted into a complementary groove of the PCB 12. In particular, a press-fit connection between both the protrusion 76 and the groove of the PCB 12 as well as the pins 72 and the complementary retention holes of the PCB 12 may be established.

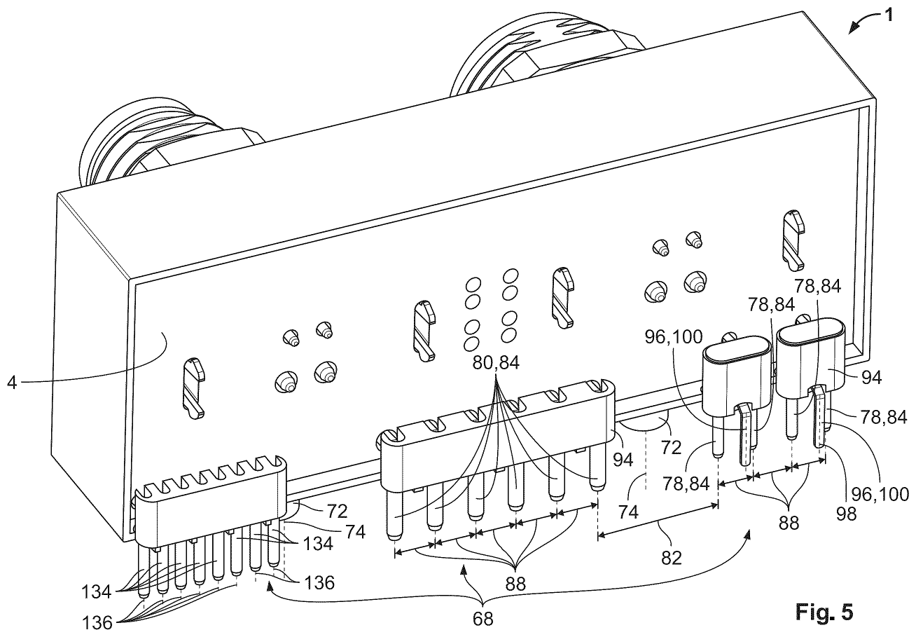

The electrical interface 68 may be provided for electrically connecting the hybrid SPE connector unit 1 to the PCB 12. As visible in FIGS. 4 and 5, the electrical interface 68 may comprise data lines 78 and power lines 80, which are spaced apart by a line distance 82. The data lines 78 may be provided for transmitting data between the PCB 12 and the hybrid SPE connector unit 1, and the power lines 80 may be provided for transmitting power between the PCB 12 and the hybrid SPE connector unit 1.

Each of the data lines 78 and each of the power lines 80 may comprise an electrical contact 84, whose longitudinal axes 86 extend parallel to each other and perpendicular to the bottom 16 of the housing 2. In the embodiment shown in FIG. 4, the longitudinal axes 86 of the electrical contacts 84 extend parallel to the longitudinal axes 74 of the pins 72 of the mechanical interface 66 of the housing 2. The electrical contacts 84 of the electrical interface 68 may be contact springs and/or pins, for example. In an embodiment, the pins 72 of the mechanical interface 66 may protrude in the same direction as any electrical contacts 84 of the electrical interface 68.

Two neighboring electrical contacts 84 of each data line 78 and each power line 80 may be spaced apart from each other by a contact pitch 88, shown in FIG. 5, which is smaller than the line distance 82. A separation of data and power transmission has the advantage that the data transmission is not disturbed through interference with the power transmission. By spacing the power lines 80 and data lines 78 apart from one another, the process of wire routing is simplified. This reduces the PCB design costs and thus the overall connectivity costs.

To further improve the separation of the data lines 78 and the power lines 80, the electrical interface 68 may comprise discrete contact fields, wherein the data lines 78 and the power lines 80 are in different contact fields. Each of the contact fields may have a different contact pitch, respectively, and/or adhere to a different connector standard.

In an embodiment of the invention, the data lines 78 may be arranged at a first side 90 of the hybrid SPE connector unit 1 and the power lines 80 may be arranged at a second side 92 of the housing 2. In particular, the first side 90 may be arranged opposite to the second side 92. As shown in FIGS. 1 and 4, the first side 90 may correspond to the backside 20 of the housing 2 and the second side 92 may correspond to the front side 18 of the housing 2. This design further improves the separation of the data lines 78 and the power lines 80, preventing the occurrence of interference between power transmission and data transmission.

According to another aspect, the data lines 78 and the power lines 80 may remain galvanically separated from the hybrid male SPE input connector 6 and at least one of the electric interface 68 and at least one female SPE output connector 8. The galvanic separation ensures that the data and power transmission via the electrical interface 68 and the data and power transmission via the SPE connectors do not interfere with each other. It also prevents voltages introduced via the SPE connectors from impairing or damaging the function of the hybrid SPE connector unit 1 or the PCB 12.

As best seen in FIGS. 5 and 6, the electrical contacts 84 of the data lines 78 and the electrical contacts 84 of the power lines 80 may be surrounded by protective caps 94. In particular, the protective caps 94 of the data lines 78 may be provided with a latch 96, having a longitudinal axis 98, shown in FIG. 5, that extends parallel to the longitudinal axes 86 of the electrical contacts 84. The latch 96 may be used as a grounding 100 and therefore may be inserted into complementary holes of the PCB 12.

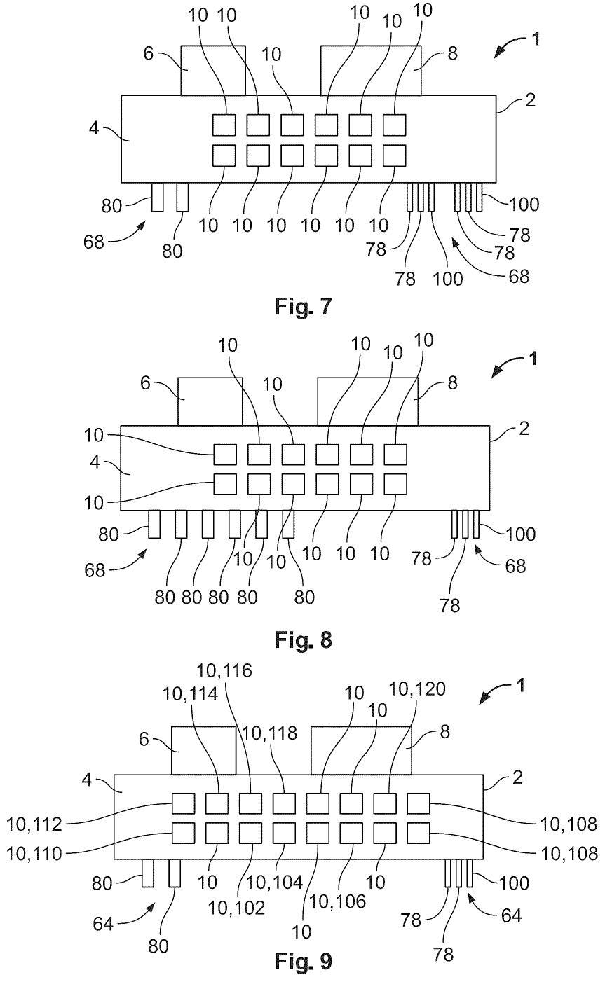

Multiple configurations of the hybrid SPE connector unit 1 are possible. Each hybrid SPE connector unit 1 shown in FIGS. 7 and 8 comprises the male hybrid SPE input connector 6, the female SPE output connector 8, the housing 2, the circuit board 4 comprising multiple components 10, and the electrical interface 68. The electrical interface 68 of the hybrid SPE connector unit 1 shown in FIG. 7 comprises two power lines 80, four data lines 78 and two groundings 100. The electrical interface 68 of the hybrid SPE connector unit 1 shown in FIG. 8 comprises six power lines 80, two data lines 78 and one grounding 100.

According to a possible embodiment as shown in the schematic view of FIG. 9, the hybrid SPE connector unit 1 comprises the circuit board 4, the male hybrid SPE input connector 6, the female SPE output connector 8, the electrical interface 64 comprising the power lines 80, the data lines 78, the grounding 100 and multiple components 10. The components 10 are mounted on the circuit board 4. The group of components 10 of the hybrid SPE connector unit 1 may comprise any of the following components 10: the transformer 102, a common mode choke 104, an LED driver 106, multiple LEDs 108, a magnetic element and/or electromagnetic element 110, a passive electronic and/or electric component 112, an active electronic and/or electric component 114, a power filter 116, a data filter 118, and a physical layer (PHY) 120.

If a component 10 acquires data or information from the electrical system, which are processed on the circuit board 12, a connection between the component 10 and the circuit board 12 may be required. By mounting the component 10 on the circuit board 12, this connection can be realized in a simple and space-saving way.

To save space on the hybrid SPE connector unit 1, at least one component 10 may be located between the male hybrid SPE input connector 6 and at least one female hybrid SPE output connector 8. Likewise, at least one component 10 may be positioned between at least two female hybrid SPE output connectors 28.

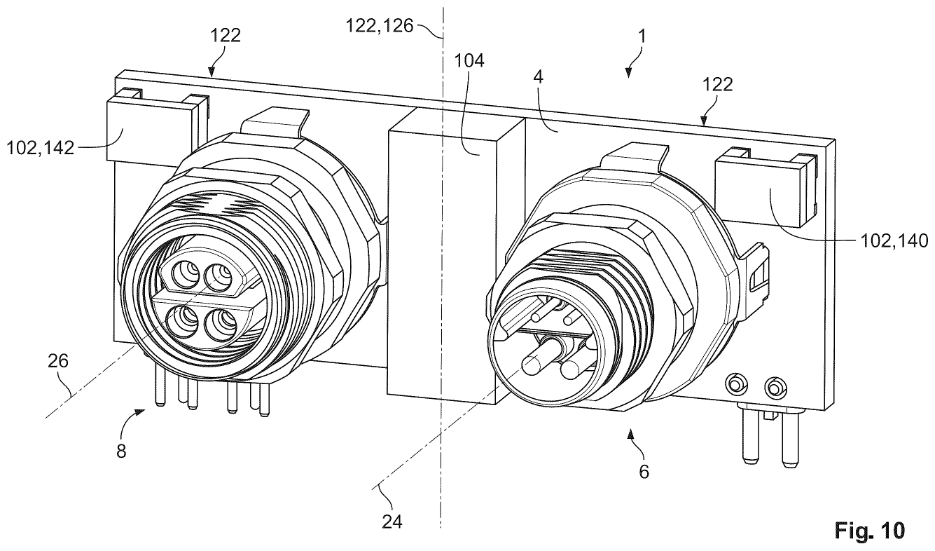

As shown in FIG. 10, the hybrid SPE connector unit 1 may also comprise multiple transformers 102. The transformers 102 may be used to provide voltage isolation between the hybrid SPE and SPE only connectors towards the electrical interface. In the embodiment shown in FIG. 10, the transformers 102 are substantially cuboid and positioned opposite with respect to a transverse axis 122 of the circuit board 4. The transformers 102 further are located at an end 122 of the circuit board 4 facing away from the PCB side 70 of the housing 2.

Each of the transformers 102 may be assigned to the male hybrid SPE input connector 6 and/or at least one female SPE output connector 8. For example, a first transformer 140 may be assigned to the male hybrid SPE input connector 6 and a second transformer 142 may be assigned to the female hybrid SPE connector 28.

The common mode choke 104 may be used for the suppression of common mode signals that are introduced into the hybrid SPE connector unit 1 via the male hybrid SPE input connector 6 and/or via the electrical interface 68 of the hybrid SPE connector unit 1. The common mode choke 104 shown in FIG. 10 has a substantially cuboid shape, which longitudinal axis 126 extends along the transverse axis 122 of the circuit board 4 and perpendicular to the longitudinal axis 24 of the male hybrid SPE input connector 6 and the longitudinal axis 26 of the female hybrid SPE connector 28. In particular, the longitudinal axis 126 of the common mode choke 104 extends between the longitudinal axis 24 of the male hybrid SPE input connector 6 and the longitudinal axis 26 of the female SPE output connector 8. The common mode choke 104 is attached to the circuit board 4 of the hybrid SPE connector unit 1.

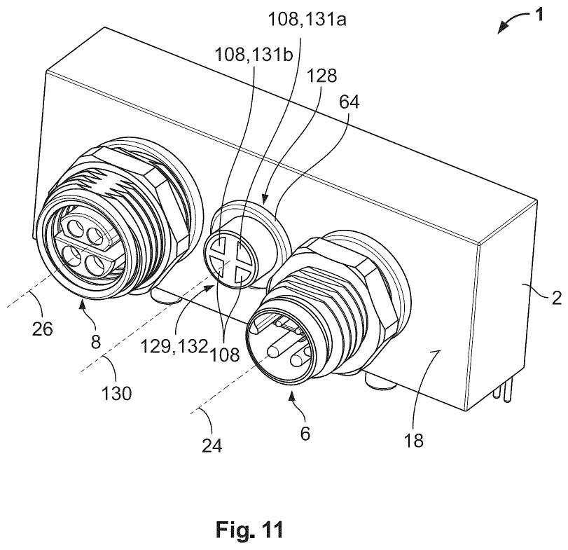

As seen in FIG. 11, the hybrid SPE connector unit 1 may comprise an LED unit 128. The LED unit 128 may be cylindrical and its longitudinal axis 130 may extend parallel to the longitudinal axis 24 of the male hybrid SPE input connector 6, parallel to the longitudinal axis 26 of the female hybrid SPE connector 28 and perpendicular to the front side 18 of the housing 2.

The LED unit 128 may comprise the toroidal sealing element 64 that abuts the front side 18 of the housing 2 and concentrically extends around the cylindrical LED unit 128.

At an end face 129 facing away from the front side 18 of the housing 2, the LED unit 128 may comprise an LED field 132, as shown in FIG. 11. The LED field 132 may comprise several LEDs 108, which activity status (on/off) may depend on parameters of the power transmission and/or the data transmission of the male SPE input connector 6 and/or at least one female SPE output connector 8. In particular, each LED 108 may be assigned to the male hybrid SPE input connector 6 and/or an SPE output connector 8 to indicate at least one parameter of the power transmission and/or one parameter of the data transmission of the assigned SPE connector 6, 8.

For example, the activity status of a first LED 131a of the LED field 132 may depend on the data speed of the male hybrid SPE input connector 6, and the activity status of a second LED 131b of the LED field 132 may depend on the power provided on the female hybrid SPE connector 28. The LED fields 132 may thus include at least one LED 108 of which activity status [on/off] depends on a data speed of the assigned SPE input/output connector 6, 8; at least one LED 108 of which activity status depends on power provided on the assigned SPE input/output connector 6, 8; and at least one LED 108 of which activity status depends on the activity of the data line of the respective SPE input/output connector 6, 8.

To supply the LED unit 128 with power, the hybrid SPE connector unit 1 may comprise LED pins 134 (see FIG. 5), via which the LED unit 128 may be electrically connected to a PCB 12 or any other device. The LED pins 134 may be connected to the circuit board 4 of the hybrid SPE connector unit 1. Longitudinal axes 136 of the LED pins 134 may extend parallel to each other and parallel to the electrical contacts 84 of the data lines 78 and the electrical contacts 84 of the power lines 80.

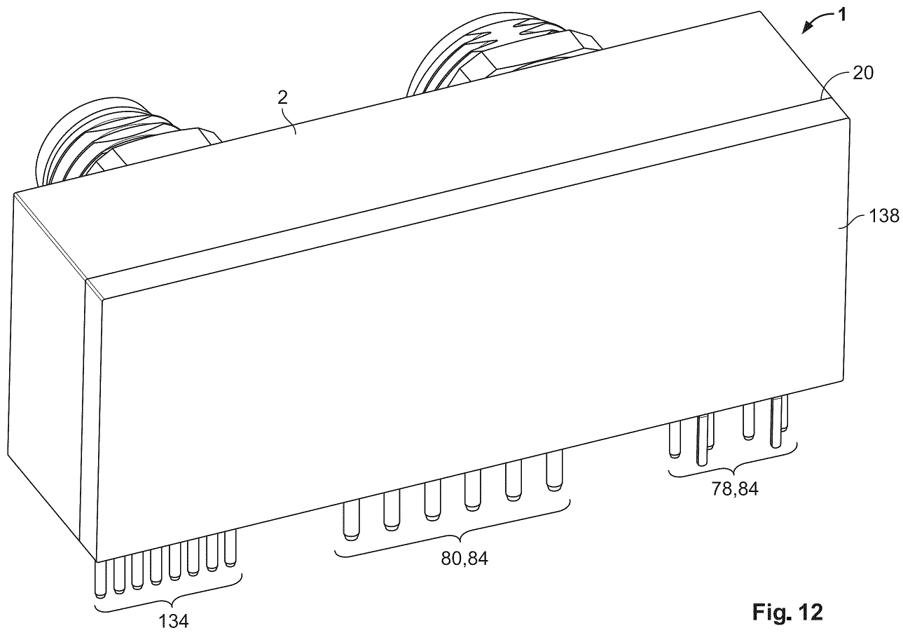

As shown in FIG. 12, the SPE hybrid connector unit 1 may also comprise a rear cover 138 that is located on the backside 20 of the housing 2. The rear cover 138 e.g. may be provided as a part of an electromagnetic shielding and/or as a part of a touch protection, in particular to protect the circuit board 4. The rear cover 138 at least partially covers the electrical contacts 84 of the data lines 78 and the power lines 80 as well as the LED pins 134.

A hybrid SPE connector unit 1 is provided that simplifies the PCB layout and which is space-saving and cost-effective. At the same time, the hybrid SPE connector unit 1 has a high degree of functional integration. This makes the hybrid SPE connector unit 1 suitable for a wide range of applications. In particular, the connector unit 1 can flexibly be adapted to a wide variety of PCB-side or SPE-line-side system configurations.

The hybrid SPE connector unit 1 is connected to mating SPE connectors on an SPE side. For a correct interconnection, it must be ensured that one specific mating SPE connector is mated with either an SPE input connector 6 or an SPE output connector 8 of the hybrid SPE connector unit. The hybrid SPE connector unit according to the invention provides that the SPE input connector 6 and the at least one SPE output connector 8 have opposite genders. Consequently, the mating SPE connector of the SPE side can only be mated with either the male hybrid SPE input connector 6 or the female SPE output connectors 8. This eliminates the risk of incorrect mating, which increases application safety and simplifies the mating process.

By providing the hybrid SPE connector unit 1 with both an electrical interface 68 and a mechanical interface 66, a PCB 12 can be connected to the hybrid SPE connector unit 1 and thus can be integrated into an SPE ring structure without the PCB 12 itself having a simplified SPE interface. The input connector 6 and the output connectors 8 may be provided for integrating the hybrid SPE connector unit 1 into an SPE ring structure or to create an SPE ring structure. In particular, both the male hybrid SPE input connector 6 and at least one of the female SPE output connectors 8 may be mated with complementary mating SPE connectors that are part of the SPE ring structure, which the hybrid SPE connector unit is connected to. In this way, the design effort of a PCB 12 is reduced, which lowers the connectivity costs.

The SPE only connector is a SPE connector which does not have any power transmission capabilities. The SPE only connector may e.g. correspond to the connectors with only two signal pins in IEC 63171-1 to IEC 63171-6.

In an embodiment, the hybrid SPE connector unit 1 may be provided with a sealing. In embodiment, the sealed hybrid SPE connector unit may comply with the standard IP67. Nevertheless, the hybrid SPE connector unit may at least support the standard IP20.

According to another aspect, the hybrid SPE connector unit 1 may be configured to provide power over data line (PoDL) functionality on at least one of the female SPE output connectors 8. The PoDL functionality uses a line, which is otherwise only used for data transmission, for power transmission. As a result, the hybrid SPE connector unit 1 does not need extra power lines and therefore allows to use simpler and smaller connectors. This allows to further reduce the size of the hybrid SPE connector unit 1. The PoDL functionality further enables the hybrid SPE connector unit 1 two be connected to an SPE topology that uses PoDL. Thus, the hybrid SPE connector unit can be interconnected with a larger variety of SPE topologies.

What is claimed is:

1. A hybrid SPE connector unit, comprising:
a housing having a PCB side with a mechanical interface and an electrical interface for mounting and connecting the hybrid SPE connector unit to a PCB;
a male hybrid SPE input connector mounted on the housing; and
at least one female SPE output connector mounted on the housing and selected from a group of connectors including a female SPE only connector and a female hybrid SPE connector.

2. The hybrid SPE connector unit of claim 1, wherein the at least one female SPE output connector is smaller than the male hybrid SPE input connector.

3. The hybrid SPE connector unit of claim 1, wherein the hybrid SPE connector unit provides a PoDL functionality on at least one of the female SPE output connectors.

4. The hybrid SPE connector unit of claim 1, wherein the electrical interface has a plurality of data lines and a plurality of power lines that are separate from one another.

5. The hybrid SPE connector unit of claim 4, wherein the electrical interface has a plurality of electrical contacts arranged at a contact pitch.

6. The hybrid SPE connector unit of claim 5, wherein the data lines and the power lines are spaced apart from one another by more than the contact pitch.

7. The hybrid SPE connector unit of claim 6, wherein the data lines are arranged at a first side of the hybrid SPE connector unit and the power lines are arranged at a second side of the hybrid SPE connector unit.

8. The hybrid SPE connector unit of claim 7, wherein the first side is opposite to the second side.

9. The hybrid SPE connector unit of claim 1, further comprising a circuit board.

10. The hybrid SPE connector unit of claim 1, further comprising a component selected from a group including a transformer, a common mode choke, an LED driver, a plurality of LEDs, a magnetic and/or electromagnetic element, a passive electronic and/or electric component, an active electronic and/or electric component, a power filter, a data filter, and a PHY.

11. The hybrid SPE connector unit of claim 10, wherein the component is mounted on a circuit board.

12. The hybrid SPE connector unit of claim 4, wherein the data lines and the power lines are galvanically separate from one another.

13. The hybrid SPE connector unit of claim 12, wherein the data lines and power lines are galvanically separated from the male hybrid SPE input connector.

14. The hybrid SPE connector unit of claim 13, wherein the data lines and power lines are galvanically separated from the electrical interface and/or the female hybrid SPE connector.

15. The hybrid SPE connector unit of claim 1, wherein the at least one female SPE output connector has an outer thread, an inner thread, and a plurality of contact pins.

16. The hybrid SPE connector unit of claim 15, wherein the at least one female SPE output connector has a pin protection that concentrically surrounds the contact pins.

17. The hybrid SPE connector unit of claim 15, wherein the at least one female SPE output connector has a screw nut that attaches the at least one female SPE output connector to the housing.

18. The hybrid SPE connector unit of claim 9, further comprising a metal bracket that mechanically connects the male hybrid SPE input connector or the at least one female SPE output connector to the circuit board.

19. The hybrid SPE connector unit of claim 18, wherein the metal bracket has a plurality of latching hooks establishing a form-locking connection with the circuit board.

20. The hybrid SPE connector unit of claim 1, further comprising a sealing element compressed between the male hybrid SPE input connector or the at least one female SPE output connector and the housing.
